(19) United States
(12) Patent Application Publication
(10) Pub. No.: US 2009/0086607 A1
(43) Pub. Date: Apr. 2, 2009

(54) Optical Information Recording and Reproducing Apparatus

(75) Inventor: Akio Fukushima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi. Ltd.,

(21) Appl. No.: 12/238,475

(22) Filed: Sep. 26, 2008

(30) Foreign Application Priority Data
Sep. 28, 2007 (JP) 2007-255912
Aug. 13, 2008 (JP) 2008-208311

(51) Int. Cl. G11B 7/00

(52) U.S. Cl. 369/103; G9B/7

(57) ABSTRACT

The invention provides an optical information recording and reproducing apparatus which can record and/or reproduce an information on both a holographic storage disc and a conventional optical storage disc, can improve a usability, and can achieve a downsizing and a low cost. The optical information recording and reproducing apparatus can record and reproduce an information on both a holographic storage disc and an optical storage disc recording and/or reproducing the information at a time of a high speed turning, by an optical pickup, and is provided with a stepping motor driving the holographic storage disc, and a direct-current motor driving the optical storage disc, and a rotating shaft of the stepping motor and a rotating shaft of the direct-current motor are constituted by a common rotating shaft.

### INCORPORATION BY REFERENCE

The present application claims priorities from Japanese applications JP 2007-255912 filed on Sep. 28, 2007, JP 2008-208311 filed on Aug. 13, 2008, the contents of which are hereby incorporated by reference into this application.

### BACKGROUND OF THE INVENTION

(1) Field of the Invention

The present invention relates to an optical information recording and/or reproducing apparatus which records an information on both of a holographic storage information recording medium, and an optical storage disc as typified by a compact disc (CD), a digital versatile disc (DVD), a Blu-ray disc or the like recording and/or reproducing the information at a time of turning, or reproduces the information recorded on both the discs, or both records and reproduces the information.

(2) Description of Related Art

Conventionally, there has been an optical information recording and reproducing apparatus which records an information on an information recording region (an information recording surface) of a reflection system of optical information recording medium (an optical storage disc) such as the compact disc (CD), the digital versatile disc (DVD) or the like, and/or reproducing the information recorded on the information recording region.

Further, in recent years, a reflection system disc having a recording density about 50 GB can be commercialized in a consumer use on the basis of a Blu-ray disc (hereinafter, refer to as “BD”) standard using a lavender color semiconductor laser, a high definition DVD (HD-DVD) standard or the like. On the other hand, the optical storage disc is desired to have a larger capacity being a match for a hard disc drive (HDD) capacity such as 100 GB to 1 TB.

However, in order to achieve the super high density mentioned above by the optical storage disc, there is required a new storage technique which is different from the conventional high density technique caused by a conventional shorter wavelength and objective lens high numerical aperture. Accordingly, in recent years, a holographic storage recording technique recording a digital information by utilizing a holography draws the attention. In accordance with the holographic storage recording technique, since it is possible to simultaneously record and reproduce a two-dimensional information by one holographic storage, and it is possible to overwrite a plurality of page data on the same place, it is effective for recording and reproducing the information having a large capacity and a high speed.

As the holographic storage recording technique mentioned above, there is a so-called angular multiplexing method which irradiates a reference light having a parallel pencil so as to interfere and record a holographic storage at the same time of focusing a signal pencil onto an optical storage disc for holographic storage (hereinafter, called as a holographic storage disc) by a lens, and further displays a different page data on a spatial light modulator while changing an angle of incidence of the reference light to the holographic storage disc so as to carry out a multiple recording (for example, refer to patent document 1 (JP-A-2004-272268)).

Further, there is introduced a holographic storage recording technique using a shift multiplexing method setting a light from an inner pixel as a signal light, setting a light from an outer ring-belt pixel as a reference light in one spatial light modulator, focusing both the light fluxes on a holographic storage disc by the same lens, and interfering the signal light with the reference light near a focal surface of the lens so as to record the holographic storage (for example, refer to patent document 2 (WO2004/102542)).

In the optical information recording and reproducing apparatus utilizing the holographic storage, in the light of an upper compatible, it is desirable that the conventional optical storage disc as typified by the BD, the DVD, the CD and the like can be recorded or reproduced by the same apparatus. However, a disc turning control method at a time of recording and reproducing the information is basically different between the holographic storage disc and the conventional optical storage disc. Accordingly, it is an actual condition that the information is recorded and reproduced while turning the disc, in the conventional optical storage disc, on the contrary, the information is recorded and reproduced in a state in which the disc remains stationary, in the holographic storage disc. In this case, since about 0.1 degree is generally necessary as a positioning precision at a time when the holographic storage disc stands still, the positioning is achieved by a stepping motor, however, it is hard to achieve the positioning by a motor for turning the conventional optical storage disc. On the other hand, since it is necessary to turn the conventional optical storage disc at a high speed about 10000 r.p.m., it is hard to use the stepping motor. Therefore, there can be considered to be necessary that two kinds of disc motors are provided in the optical information recording and reproducing apparatus recording the information on the information recording regions of both the holographic storage information recording medium and the conventional optical storage disc, and/or reproducing the information recorded on the information recording regions. Accordingly, it is hard to downsize the optical information recording and reproducing apparatus, and a cost is increased.

In this case, in order to downsize the optical information recording and reproducing apparatus and achieve a cost reduction thereof, it is desirable to make a transport mechanism of the disc, and a mechanism such as a turn table or the like in common. Although it is not for the optical information recording and reproducing apparatus, there is a conventional rotating mechanism in which a rotating shaft of the stepping motor and a rotating shaft of a direct-current motor are made in common (for example, refer to patent document 3 (JP-A-8-126288), patent document 4 (JP-A-1-270760), patent document 5 (JP-A-63-277455) and patent document 6 (JP-A-58-39261)).

However, there is not introduced any structure which records and reproduces the information on both the holographic storage disc and the optical storage disc, as the consumer optical information recording and reproducing apparatus. Further, as mentioned above, the rotating mechanisms described in the patent documents 3 to 6 are not structured such as to position the holographic storage disc and turn the optical storage disc, and a specific structure and a control method necessary for recording and reproducing the information on both the holographic storage disc and the optical storage disc are not referred, as a matter of course.

In the case of the optical information recording and reproducing apparatus which records and reproduces the information on both the holographic storage disc and the optical storage disc, the information recording and reproducing system is absolutely different between the holographic storage disc and the conventional optical storage disc. Accordingly, it is desirable to automatically discriminate which of the conventional optical storage disc and the holographic storage disc the disc loaded to the optical information recording and reproducing apparatus is, and construct such as to be capable of recording and reproducing the information in accordance with the recording and reproducing system corresponding to the disc on the basis of the result of discrimination. Then, it is possible to use the optical information recording and reproducing apparatus without being aware of the kind of the disc loaded by the user, by constructing the optical information recording and reproducing apparatus as mentioned above, and it is possible to improve a usability of the optical information recording and reproducing apparatus.

### BRIEF SUMMARY OF THE INVENTION

The present invention is made by taking the circumstances mentioned above into consideration, and an object of the present invention is to provide an optical information recording and reproducing apparatus which can record and/or reproduce an information on both a holographic storage disc and a conventional optical storage disc, can improve a usability, and can achieve a downsizing and a low cost.

In order to achieve the object, in accordance with the present invention, there is provided an optical information recording and reproducing apparatus recording an information on both a holographic storage disc and an optical storage disc recording and/or reproducing the information at a time of turning, and/or reproducing the information recorded on the both, by an optical pickup including a stepping motor driving the holographic storage disc, and a direct-current motor driving the optical storage disc, wherein a rotating shaft of the stepping motor and a rotating shaft of the direct-current motor are constituted by a common rotating shaft.

In the optical information recording and reproducing apparatus in accordance with the present invention, it is preferable that the optical information recording and reproducing apparatus further includes a turn table arranged in the rotating shaft and being capable of installing both of the holographic storage disc, the optical storage disc and the other disc, a disc discriminating means discriminating which of the holographic storage disc and the optical storage disc the disc installed to the turn table is, and a drive means selecting and driving a motor corresponding to the disc discriminated by the discriminating means.

In the optical information recording and reproducing apparatus in accordance with the present invention, it is preferable that the stepping motor and the direct-current motor are overlapped in an axial direction of the rotating shaft and the direct-current motor is arranged in the turn table side.

In the optical information recording and reproducing apparatus in accordance with the present invention, it is preferable that the stepping motor and the direct-current motor are overlapped in an axial direction of the rotating shaft and the stepping motor is arranged in the turn table side.

In the optical information recording and reproducing apparatus in accordance with the present invention, it is preferable that the stepping motor and the direct-current motor are arranged concentrically around the rotating shaft, the stepping motor is arranged in an outer side of the direct-current motor, and a rotor of the stepping motor and a rotor of the direct-current motor are constituted by a common rotor.

In the optical information recording and reproducing apparatus in accordance with the present invention, it is preferable that the stepping motor and the direct-current motor are arranged concentrically around the rotating shaft, and the direct-current motor is arranged in an outer side of the stepping motor.

In the optical information recording and reproducing apparatus in accordance with the present invention, it is preferable that the optical information recording and reproducing apparatus measures a frequency of a signal generated in a coil of the stepping motor at a time when the direct-current motor is driven.

In the optical information recording and reproducing apparatus in accordance with the present invention, it is preferable that the optical information recording and reproducing apparatus shuts off a current path feeding an electric current to the stepping motor in a circuit manner at a time when the direct-current motor is driven.

In the optical information recording and reproducing apparatus in accordance with the present invention, it is preferable that the direct-current motor is constituted by a brushless motor having a Hall element, and the optical information recording and reproducing apparatus measures a signal generated in the Hall element at a time when the stepping motor is driven.

In the optical information recording and reproducing apparatus in accordance with the present invention, it is preferable that the optical information recording and reproducing apparatus measures a frequency of a signal generated in a coil of the direct-current motor at a time when the stepping motor is driven.

In the optical information recording and reproducing apparatus in accordance with the present invention, it is preferable that the optical information recording and reproducing apparatus shuts off a current path feeding an electric current to the direct-current motor in a circuit manner at a time when the stepping motor is driven.

In the optical information recording and reproducing apparatus in accordance with the present invention, it is preferable that the optical information recording and reproducing apparatus shorts between coil terminals of the direct-current motor in a circuit manner at a time of carrying out a control by the stepping motor and setting the holographic storage disc in a standstill state and/or rotating state.

In the optical information recording and reproducing apparatus in accordance with the present invention, it is preferable that the optical information recording and reproducing apparatus turns the holographic storage disc by the direct-current motor at a time of turning the holographic storage disc for carrying out any process of a pre-cure and a post-cure with respect to the holographic storage disc.

In the optical information recording and reproducing apparatus in accordance with the present invention, it is preferable that the optical information recording and reproducing apparatus carries out a rotating speed control by the direct-current motor so as to continuously turn the holographic storage disc within a predetermined rotating speed, at a time of turning the holographic storage disc for carrying out any process of a pre-cure and a post-cure with respect to the holographic storage disc.

In the optical information recording and reproducing apparatus in accordance with the present invention, it is preferable that the optical information recording and reproducing apparatus further includes a turn table arranged in the rotating shaft and being capable of installing both of the holographic storage disc and the optical storage disc, a disc discriminating means discriminating which of the holographic storage disc, the optical storage disc and the other disc the disc installed to the turn table is, and a motor drive means turning the disc at a time of the discriminating means, wherein the motor drive means drives the direct-current motor so as to turn the disc at a time when the disc discriminating means discriminates the disc.

In the optical information recording and reproducing apparatus in accordance with the present invention, it is preferable that the optical information recording and reproducing apparatus further includes a turn table arranged in the rotating shaft and being capable of installing both of the holographic storage disc and the optical storage disc, a disc discriminating means discriminating which of the holographic storage disc, the optical storage disc and the other disc the disc installed to the turn table is, and a motor drive means turning the disc at a time of the discriminating means, wherein the motor drive means carries out a rotating speed control by the direct-current motor so as to continuously turn the disc within a predetermined rotating speed range at a time when the disc discriminating means discriminates the disc.

In accordance with the present invention, it is possible to record the information on both of the information recording region of the holographic storage information recording medium and the information recording region of the existing optical storage disc as typified by the BD, the DVD, the CD and the like by the same apparatus, and/or reproduce the information recorded on both the information recording regions, it is possible to improve a usability, and it is possible to provide the optical information recording and reproducing apparatus achieving the downsizing and the low cost.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a schematic view showing an outline of a drive corresponding to a constituent element of an optical information recording and reproducing apparatus in accordance with an embodiment of the present invention;

FIG. 2 is a view showing an example of an optical system of an optical pickup corresponding to the constituent element of the optical information recording and reproducing apparatus shown in FIG. 1;

FIG. 3 is a view showing a motor portion of the optical information recording and reproducing apparatus shown in FIG. 1 in a simplified manner, and a view which is partly shown by a cross section;

FIG. 4 is a flow chart provided for explaining a recording and reproducing preparation process in the optical information recording and reproducing apparatus shown in FIG. 1;

FIG. 5 is a flow chart provided for explaining a recording process in the optical information recording and reproducing apparatus shown in FIG. 1;

FIG. 6 is a flow chart provided for explaining a reproducing process in the optical information recording and reproducing apparatus shown in FIG. 1;

FIG. 7 is a flow chart showing a specific process content of a controller relating to a disc discriminating process in the optical information recording and reproducing apparatus in accordance with the embodiment of the present invention;

FIG. 8 is a view showing a motor portion of an optical information recording and reproducing apparatus in accordance with the other embodiment of the present invention in a simplified manner, and a view which is partly shown by a cross section;

FIG. 9 is a view showing a motor portion of an optical information recording and reproducing apparatus in accordance with the other embodiment of the present invention in a simplified manner, and a view which is partly shown by a cross section;

FIG. 10 is a view showing a motor portion of an optical information recording and reproducing apparatus in accordance with the other embodiment of the present invention in a simplified manner, and a view which is partly shown by a cross section;

FIG. 11 is a view showing a motor portion of an optical information recording and reproducing apparatus in accordance with the other embodiment of the present invention in a simplified manner, and a view which is partly shown by a cross section;

FIG. 12 is a view showing a motor portion of an optical information recording and reproducing apparatus in accordance with the other embodiment of the present invention in a simplified manner, and a view which is partly shown by a cross section; and

FIG. 13 is a view showing a motor portion of an optical information recording and reproducing apparatus in accordance with the other embodiment of the present invention in a simplified manner, and a view which is partly shown by a cross section.

### DETAILED DESCRIPTION OF THE INVENTION

Next, a description will be given of an optical information recording and reproducing apparatus in accordance with preferable embodiments of the present invention with reference to the accompanying drawings. In this case, the embodiments described below are provided as an exemplification for explaining the present invention, and the present invention is not limited to the embodiments. Accordingly, the present invention can be executed by various aspects within the scope of the present invention. Further, in the present embodiment, a description will be given by calling a medium in which an information is recorded and/or reproduced by utilizing a holography as “holographic storage disc”, and calling a medium which is typified by the BD, the DVD, the CD and the like and in which the information is recorded and/or reproduced at a time of turning as “optical storage disc”.

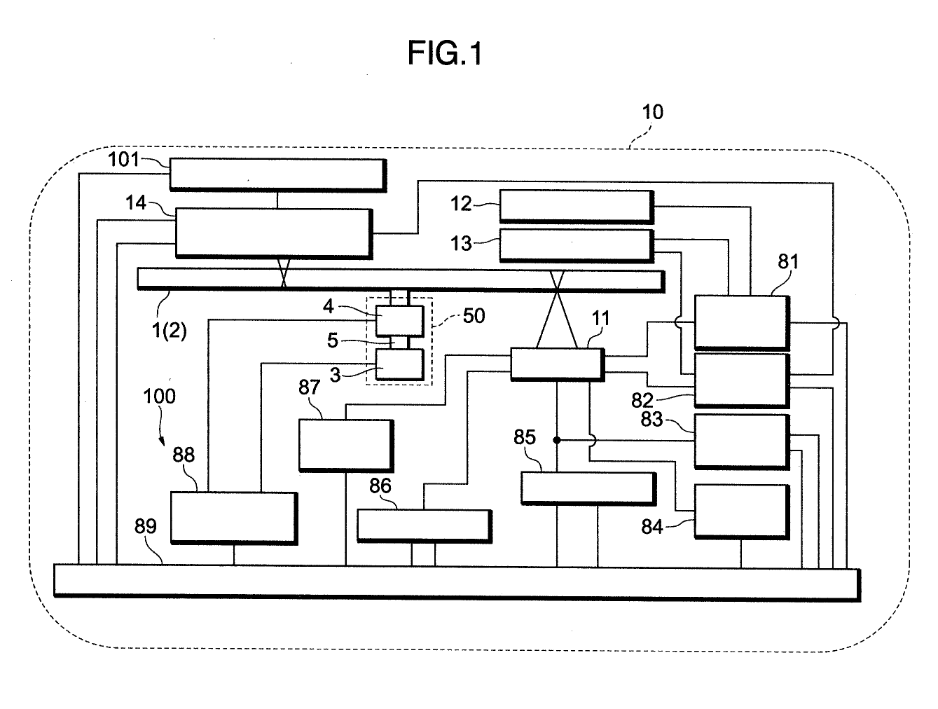

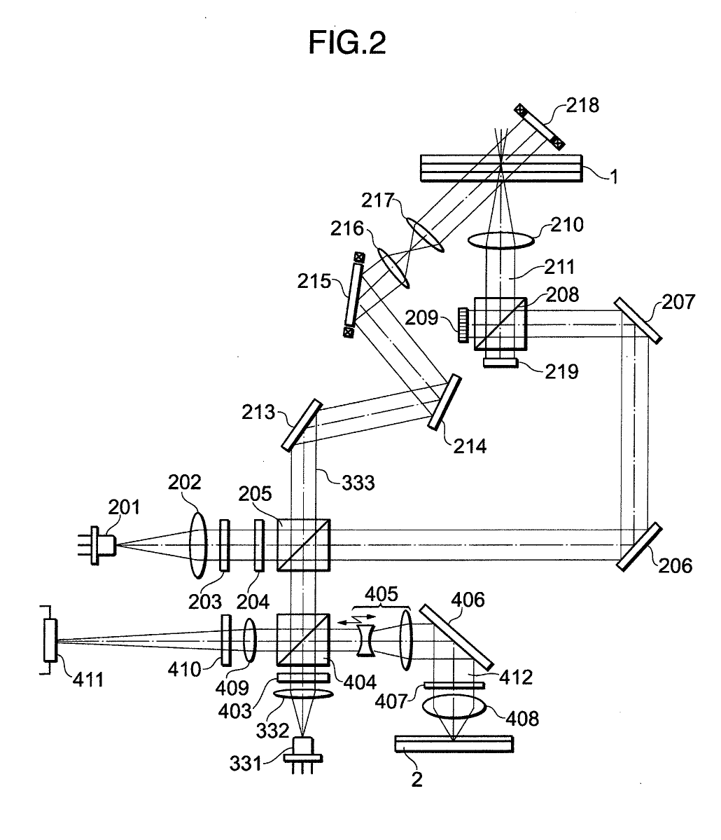

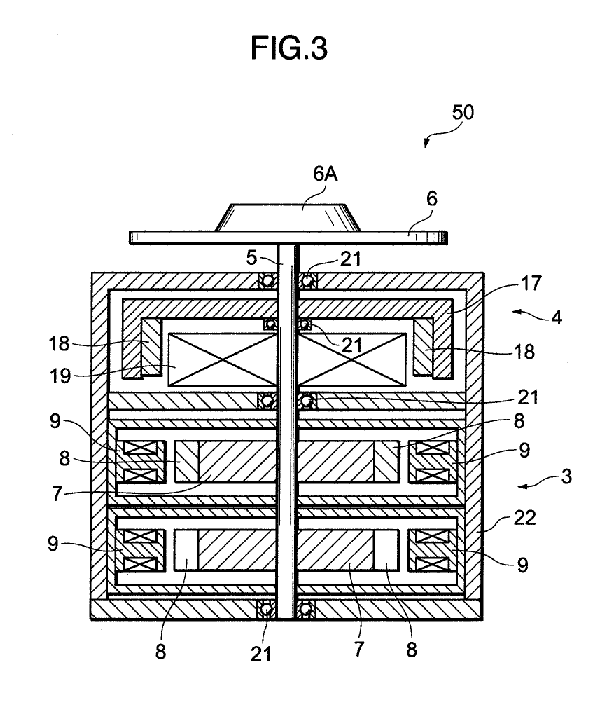

FIG. 1 is a schematic view showing an outline of a drive corresponding to a constituent element of an optical information recording and reproducing apparatus in accordance with an embodiment of the present invention, FIG. 2 is a view showing an example of an optical system of an optical pickup corresponding to the constituent element of the optical information recording and reproducing apparatus shown in FIG. 1, and FIG. 3 is a view showing a motor portion of the optical information recording and reproducing apparatus shown in FIG. 1 in a simplified manner, and a view which is partly shown by a cross section. In this case, in each of the drawings mentioned above, in order to easily understand the description, the description is given without bringing a thickness, a size, an enlargement ratio, a reduction ratio and the like of each of the members into line with actual ones.

As shown in FIG. 1, an optical information recording and reproducing apparatus 10 in accordance with the present embodiment is provided with a motor portion 50 for driving a holographic storage disc 1 corresponding to a holographic storage information recording medium and an optical storage disc 2, an optical pickup 11 introducing a laser light to each of the holographic storage disc 1 and the optical storage disc 2 so as to record and reproduce the information, a phase conjugate optical system 12, a disc cure optical system 13, a disc rotation angle detecting optical system 14, and a control portion 10 controlling them.

The motor portion 50 is provided with a stepping motor 3 driving a holographic storage disc, and a direct-current motor 4 driving an optical storage disc 2, as shown in FIGS. 1 and 3. The stepping motor 3 and the direct-current motor 4 have a rotating shaft 5 which is in common with each other, and are arranged side by side (arranged in an overlapping manner) along an axial direction of the rotating shaft 5. Further, a turn table 6 which can install both the holographic storage disc and the optical storage disc 2 is arranged in a leading end in a side in which the direct-current motor 4 is arranged in the rotating shaft 5 (an upper leading end of the rotating shaft in the present embodiment). A clamp portion 6A is arranged in a center portion of an upper surface of the turn table 6. The clamp portion 6A is provided for detachably chucking the holographic storage disc and the optical storage disc 2 at a time when the holographic storage disc and the optical storage disc 2 are mounted.

The stepping motor 3 is provided with a rotor 7 attached to an outer periphery of the rotating shaft 5, a magnet 8 attached to an outer periphery of the rotor 7, and a coil 9 arranged in an outer peripheral side so as to be spaced from the magnet 8 and corresponding to a stator. On the other hand, the direct-current motor 4 is provided with a rotor 17 attached to an outer periphery of the rotating shaft 5 and formed as an approximately C-shaped cross section, a magnet 18 attached to an inner peripheral surface of the rotor 17, and a coil 19 arranged in an inner peripheral side so as to be spaced from the magnet 18 and corresponding to a stator. In this case, reference numeral 21 denotes a bearing, and reference numeral 22 denotes a casing of the motor portion 50.

In the motor portion 50 in accordance with the present embodiment, since the stepping motor 3 and the direct-current motor 4 have the rotating shaft 5 which is in common with each other, it is possible to achieve a downsizing and a low cost. Further, since an outer diameter of the stepping motor 3 is constructed approximately in the same manner as an outer diameter of the direct-current motor 4, and an outer diameter of the motor portion 50 is identical to the conventional motor which is provided only with the direct-current motor, it is possible to simply divert a mechanism of the conventional motor. Further, since the outer diameter of the stepping motor 3 is designed comparatively large, there is an advantage that it is possible to easily increase a number of poles, and it is easy to improve an angular resolution. Further, since a length (a thickness) of the stepping motor 3 in a direction along the rotating shaft 5 can be made thin, it is possible to make a whole thickness (height) of the motor portion 50. Further, in the motor portion 50 in accordance with the present embodiment, since the direct-current motor 4 is arranged in the turn table 6 side, it is possible to make a distance between the direct-current motor 4 and the turn table 6 equal to a distance between the direct-current motor in the conventional motor which is provided only with the direct-current motor and the turn table. Therefore, there is obtained an advantage that a shaft resonance is hard to be generated.

The optical pickup 11 is structured such as to be movable along a guide shaft (not shown), and record an information in common on an information recording region of the holographic storage disc 1 installed to the turn table 6 and an information recording region of the optical storage disc 2, and reproduce the recorded information. The optical pickup 11 irradiates a reference light and a signal light to the holographic storage disc 1 so as to record a digital information by utilizing a holography in the case of recording on the holographic storage disc 1 installed to the turn table 6. At this time, the recorded information signal is sent to a spatial light modulator 209 (refer to FIG. 2) mentioned below within the optical pickup 11 via a signal generating circuit 86 by a controller 89, and the signal light is modulated by the spatial light modulator 209. An irradiation time of the reference light and the signal light irradiated to the holographic storage disc 1 can be regulated by controlling an opening and closing time of a shutter 203 (refer to FIG. 2) mentioned below within the optical pickup 11 by the controller 89 via a shutter control circuit 87.

In the case of reproducing the information recorded in the holographic storage disc 1, a phase conjugate light of the reference light emitted from the optical pickup 11 is generated by the phase conjugate optical system 12. In this case, the phase conjugate light means a light wave traveling in an inverse direction while keeping the same wave surface as that of an input light. A reproduction light reproduced by the phase conjugate light is detected by a light detector 219 (refer to FIG. 2) mentioned below within the optical pickup 11, and a signal is reproduced by a signal processing circuit 85.

In order to carry out the recording and the reproduction mentioned above by circumference of the holographic storage disc, the holographic storage disc 1 is turned by the stepping motor 3. In order to obtain a sufficient light energy for stably recording the information on the holographic storage disc 1, it is desirable that the holographic storage disc 1 stands still at a time of recording and reproducing the information. Accordingly, in the present embodiment, there is employed the stepping motor 3 which can stably operate the rotation and the standstill of the holographic storage disc 1, for this purpose.

The disc cure optical system 13 is structured such as to generate a light beam used for a pre-cure and a post-cure of the holographic storage disc 1. In this case, the pre-cure is a pre step of previously irradiating a predetermined light beam before irradiating the reference light and the signal light to a desired position at a time of recording the information at the desired position of the holographic storage disc 1. Further, the post-cure is a post step of irradiating a predetermined light beam for making it impossible to add a postscript at a desired position after recording the information at the desired position within the holographic storage disc 1.

The disc rotation angle detecting optical system 14 is structured such as to detect an angle of rotation of the holographic storage disc 1. In the case of regulating the holographic storage disc 1 to a predetermined angle of rotation, a signal corresponding to the angle of rotation of the holographic storage disc 1 is detected by the disc rotation angle detecting optical system 14, the drive of the stepping motor 3 is controlled via a disc rotation motor control circuit 88 by the controller 89 while using the detected signal, and the angle of rotation of the holographic storage 1 is controlled.

Each of the optical pickup 11, the disc cure optical system 13 and the disc rotation angle detecting optical system 14 has a light source in its inner portion, and a predetermined light source driving current is fed from a light source drive circuit 82 to each of the light sources. Then, each of the light sources can emit a light beam at a predetermined amount of light.

Further, the optical pickup 11, the phase conjugate optical system 12, and the disc cure optical system 13 are provided with a mechanism which can slide its position in a radial direction of the holographic storage disc 1, and a position control is carried out via an access control circuit 81. Further, it is possible to record and reproduce on a whole surface of the disc on the basis of the position control.

On the other hand, in the case that the optical pickup 11 records on the optical storage disc 2, it emits the signal light onto the optical storage disc 2 installed to the turn table 6 so as to record the information. The recorded information signal is sent into the optical pickup 11 via the signal generating circuit 86 by the controller 89, and the signal light is focused as a light spot on the optical storage disc 2 by an objective lens 408 (a focusing lens) and the information is recorded.

Further, the information recorded on the optical storage disc 2 is reproduced by converting the reflection light from the optical storage disc 2 into an electric signal by the optical pickup 11 so as to send to the signal processing circuit 85. In the recording and the reproduction mentioned above, a focusing (an automatic focus) of the light spot on the light disc 2 and a positioning (a tracking) onto a track (a guide groove) are carried out via a servo signal generating circuit 83 and a servo control circuit 84.

In the recording and the reproduction of the information on the optical storage disc 2, it is necessary to turn the optical storage disc 2 some thousands of turns per minute for obtaining a high transfer rate such as some hundreds of Mbps. For this purpose, in the present embodiment, there is employed the direct-current motor 4 which can stably turn the optical storage disc 2 at a high speed, as a motor driving the optical storage disc 2.

A control portion 100 is structured such as to be provided with the access control circuit 81 mentioned above, the light source drive circuit 82, the servo signal generating circuit 83, the servo control circuit 84, the signal processing circuit 85, the signal generating circuit 86, the shutter control circuit 87, the disc rotation motor control circuit 88, the controller 89, and a reflection system disc detecting circuit 101.

In this case, in order to achieve the downsizing of the optical information recording and reproducing apparatus 10, the optical pickup 11, the phase conjugate optical system 12, the disc cure optical system 13, and the disc rotation angle detecting optical system 14 may be simplified by bringing some optical system structures or all the optical system structures together into one. Further, since the recording technique utilizing the holography is a technique which can record a super high density information, for example, there is a tendency that an allowable error with respect to an incline and a displacement of the holographic storage disc 1 becomes extremely small. Accordingly, a mechanism detecting a shift amount of a shift factor having a small allowable error, for example, an incline, a displacement or the like of the holographic storage disc 1 may be provided within the optical pickup 11, a signal for a servo control may be generated by the servo signal generating circuit 83, and a servo mechanism correcting the shift amount via the servo control circuit 84 may be provided within the optical information recording and reproducing apparatus 10.

Next, a description will be given of an optical motion in the case of recording the signal on the holographic storage disc 1 by utilizing the holography or reproducing the information recorded on the holographic storage disc 1, by means of the optical pickup 11, and an optical motion in the case of recording the information on the optical storage disc 2 or reproducing the information recorded on the optical storage disc 2, with reference to FIG. 2.

In the case of recording the signal on the holographic storage disc 1 or reproducing the information recorded on the holographic storage disc 1 by utilizing the holography, a light beam emitted from a laser light source 201 emitting the a light beam having a high coherence is used as a signal light beam and a reference light beam. In the case of recording the information on the optical storage disc 2 or reproducing the information recorded on the optical storage disc 2, a laser light source 331 emitting a light beam having a lower coherence than the laser light source 201 is used for the purpose of suppressing a laser noise.

The recording on the holographic storage disc 1 can be achieved as follows. First of all, the light beam outgoing from the light source 201 transmits a collimate lens 202 and inputs to the shutter 203. When the shutter 203 is open, the light beam passes through the shutter 203, is thereafter controlled its direction of polarization by an optical element 204, for example, constituted by a half-wave plate or the like so that a ratio of light amount between a P polarization and an S polarization comes to a desired ratio, and thereafter comes into a PBS prism 205. The light beam transmitting the PBS prism 205 is changed its light path by reflection mirrors 206 and 207 so as to reach a PBS prism 208, and is introduced into the spatial light modulator 209 via the PBS prism 208. Further, the signal light beam 211 to which the information is added by the spatial light modulator 209 is focused to the holographic storage disc 1 by the objective lens 210.

On the other hand, the light beam reflected from the PBS prism 205 serves as a reference light beam 333, and comes into a lens 216 via mirrors 213 and 214 and a galvanometer mirror 215. The lens 216 plays a part in focusing the reference light beam 333 onto a back focus surface of the lens 217, and the reference light beam once focused on the back focus surface of the lens 217 is input again as a parallel light into the holographic storage disc 1 by the lens 217. In this case, the galvanometer mirror 215 is a mirror which can be turned, and it is possible to set an angle of incidence of the reference light 333 coming into the holographic storage disc 1 on the basis of this rotation.

As mentioned above, an interference fringe pattern is formed within the holographic storage disc 1 by inputting the signal light beam and the reference light beam in the holographic storage disc 1 in such a manner as to lap over each other, and the information is recorded by writing the pattern on the information recording region. Further, since it is possible to change the angle of incidence of the reference light beam coming into the holographic storage disc 1 by turning the galvanometer mirror 215, it is possible to record in accordance with an angle multiplex.

Next, in the case of reproducing the information recorded on the holographic storage disc 1, the phase conjugate light is generated by inputting only the reference light beam 333 to the holographic storage disc 1, and reflecting the light beam transmitting the holographic storage disc 1 by the galvanometer mirror 218. The reproduced light beam reproduced by the phase conjugate light comes into the light detector 219 while transmitting the objective lens 210 and the PBS prism 208, and can reproduce the recorded signal.

In this case, in the present embodiment, there is listed up the example in which the signal light and the reference light come into the holographic storage disc 1 by the separate lenses, however, it is possible to employ a system in which one objective lens is used, and the signal light and the reference light come into the one objective lens so as to be irradiated onto the disc.

On the other hand, in the case of recording the information on the optical storage disc 2 or reproducing the information recorded on the optical storage disc 2, the light beam emitted from the laser light source 331 is used. First of all, the light beam emitted from the light source 331 transmits a collimate lens 332, and reaches a polarization direction converting element 403. In the polarization direction converting element 403, the light beam coming into a PBS prism 404 is reflected by controlling a polarization direction in such a manner that a polarization of the light beam emitted from the polarization direction converting element 403 comes to the S polarization, and the light beam is introduced to a light path of a beam expander 405. Next, the light beam transmitting the beam expander 405 comes into an objective lens 408 in a state of a circular polarization of light via a reflection mirror 406 and an optical element 407, for example, constituted by a quarter-wave plate or the like, and is focused onto the information recording region (the information recording surface) of the optical storage disc 2, and the information is recorded.

Further, the light beam reflected from the optical storage disc 2 transmits the PBS prism 404 via the objective lens 408, the optical element 407, the reflection mirror 406, and the beam expander 405 while tracking back the inverse light path to the outward path mentioned above. The light beam transmitting the PBS prism 404 transmits a lens 409, is thereafter diffracted and separated into a desired light beam by a detection side diffraction grating 410 in such a manner as to detect an information signal, a desired servo signal or the like, and is thereafter focused onto a light detector 411.

As mentioned above, the optical pickup 11 can record or reproduce the information by switching (selecting) between the emission of the light from the laser light source 201 and the emission of the light from the laser light source 331, that is, selectively inputting the light to any one of the objective lens 210 and the objective lens 408.

In this case, in the present embodiment, the description is given of the case that in the case of recording the signal on the holographic storage disc 1, or reproducing the information recorded on the holographic storage disc 1, by utilizing the holography, the light beam emitted from the laser light source 201 emitting the light beam having the high coherence is used as the signal light beam and the reference light beam, and in the case of recording the information on the optical storage disc 2 or reproducing the information recorded on the optical storage disc 2, the laser light source 331 emitting the light beam having the lower coherence than the laser light source 201 is used. However, the structure is not limited, but it is possible to select whether the light beam emitted from the laser light source 331 is irradiated as a curing light beam onto the holographic storage disc 1 or irradiated as the light beam for recording or reproducing the optical storage disc 2 onto the optical storage disc 2, by controlling the light amount irradiated on the basis of a combination between the polarization direction converting element 403 and the PBS prism 404.

The following reasons can be listed up. In general, a light beam having a high coherence such as a turnable laser or the like is required for the signal light beam and the reference light beam in the light of the holography. On the other hand, a light beam having a low coherence is required for the curing light beam for preventing a useless holographic storage causing a noise from being formed in the light of a signal quality. Accordingly, the light beam emitted from the laser light source 331 having the low coherence can be used as the curing light beam. In this case, the polarization direction converting element 403 can be regulated, for example, by setting out and in a liquid crystal element and a wavelength plate. Further, the curing light beam passes through the collimate lens 332 and the polarization direction converting element 403, thereafter transmits the PBS prism 404 and the PBS prism 205, and is irradiated onto the holographic storage disc 1 along the same path as the reference light beam.

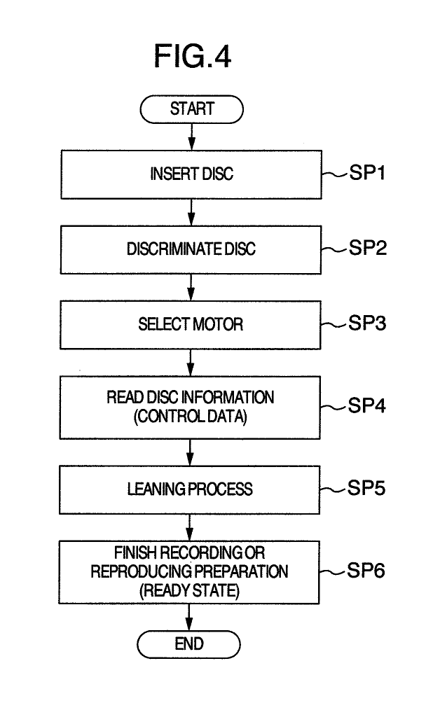

Next, a description will be given of a flow at a time of recording the information onto the disc of the optical information recording and reproducing apparatus 10 and reproducing the information recorded on the disc, with reference to FIGS. 4 to 6.

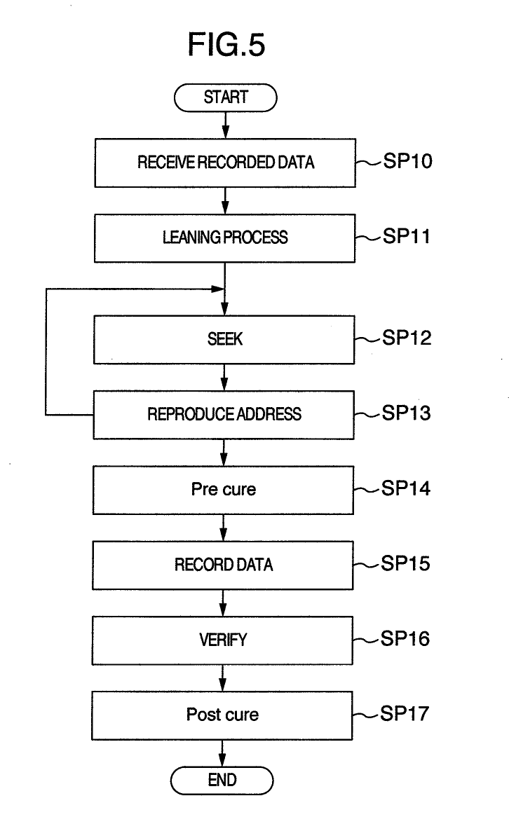

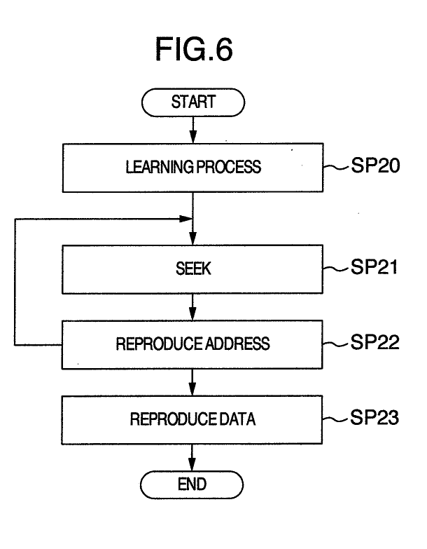

FIG. 4 is a flow chart provided for explaining a recording and reproducing preparation process in the optical information recording and reproducing apparatus shown in FIG. 1, FIG. 5 is a flow chart provided for explaining a recording process in the optical information recording and reproducing apparatus shown in FIG. 1, and FIG. 6 is a flow chart provided for explaining a reproducing process in the optical information recording and reproducing apparatus shown in FIG. 1. In this case, the description is given particularly of the flow relating to the recording and the reproduction with respect to the holographic storage disc.

As shown in FIG. 4, if the disc is inserted (SP1), the optical information recording and reproducing apparatus 10 carries out, for example, a disc discrimination discriminating whether or not the inserted disc is the disc (the holographic storage disc) recording or reproducing a digital information by utilizing the holography (SP2). In the disc discrimination, there are a method of discriminating in a state in which the optical storage disc is turned and a method of discriminating in a state in which the optical storage disc remains stationary, and they respectively have features. For example, in the case of discriminating the disc in the state in which the optical storage disc is turned, a light energy is not focused to a specific point of the installed optical storage disc on the basis of the rotation. Accordingly, it is easy to prevent the optical storage disc or the information recorded on the optical storage disc from being deteriorated due to an excessive concentration of the light energy. Further, in the case of discriminating the disc in the state in which the optical storage disc remains stationary, it is possible to prevent a phenomenon caused by the disc rotation such as a vibration generated by a mass eccentricity of the optical storage disc, a surface vibration due to an incline of the turn table to which the optical storage disc is installed and an unevenness of the optical storage disc itself, an eccentricity from the rotating shaft of the track formed circumferentially and the like, and it is possible to more easily detect the signal used for discriminating the optical storage disc and discriminate thereby.

Since there is the advantage and the disadvantage as mentioned above whether or not the disc is turned or remains stationary in the disc discrimination, it is not uniquely determined whether or not the disc is turned or remains stationary, however, in the case of discriminating the disc in the turning state, a turning state such as a smoothness of the disc rotation, a controllability of the rotating speed or the like may affect the discriminating process. Therefore, it is desirable to carry out the disc rotation by using the direct-current motor which is generally considered to have a better turning state than the stepping motor. In the present embodiment, in the case of turning the disc at a time of discriminating the disc, the control is carried out in such a manner as to turn the optical storage disc by using the direct-current motor. Further, in the present embodiment, it is possible to stably discriminate by discriminating the disc after continuously turning the disc so as to come within a predetermined rotating speed range by carrying out the rotating speed control by the direct-current motor.

Next, the motor corresponding to the discriminated disc is selected and driven. Specifically, if the inserted disc is determined to be the holographic storage disc as a result of the disc discrimination, the control signal is given to the coil 9 of the stepping motor 3 via the disc rotation motor control circuit 88, and the stepping motor 3 is driven. On the other hand, if the inserted disc is determined to be the optical storage disc 2, the control signal is given to the coil 19 of the direct-current motor 4 via the disc rotation motor control circuit 88, and the direct-current motor 4 is driven (SP3).

In the case that the inserted disc is the holographic storage disc, the optical information recording and reproducing apparatus 10 reads a control data provided in the holographic storage disc, and acquires, for example, the information relating to the disc, and the information relating to various setting conditions at a time of recording or reproducing (SP4). If the optical information recording and reproducing apparatus 10 finishes reading the control data, the optical information recording and reproducing apparatus 10 carries out various regulations in correspondence to the control data and a learning process relating to the optical pickup 11 (SP5), and a preparation of the recording or the reproduction is finished (SP6).

The motion flow from the preparation finish state to the recording of the information is as shown in FIG. 5. In other words, the optical information recording and reproducing apparatus 10 first of all receives the data to be recorded, and send the information in correspondence to the data to the spatial light modulator 209 in the holographic storage optical system within the optical pickup 11 (SP10). Thereafter, the optical information recording and reproducing apparatus 10 carries out various learning processes in advance in such a manner as to record the information having a high quality on the holographic storage disc (SP11), and sets positions of the optical pickup 11 and the disc cure optical system 13 at a predetermined position of the holographic storage disc while repeating a seek motion and an address reproduction (SP12 and SP13).

Next, the optical information recording and reproducing apparatus 10 carries out a pre-cure process pre curing a predetermined region by using the light beam emitted from the disc cure optical system 13 (SP14), and records the data by using the reference light and the signal light emitted from the holographic storage optical system of the optical pickup 11 (SP15). After recording the data, the optical information recording and reproducing apparatus 10 verifies the data as occasion demands (SP16), and carries out a post-cure process post curing by using the light beam emitted from the disc cure optical system 13 (SP17). In this case, both the pre-cure process and the post-cure process are a process giving a predetermined light energy to a comparatively wide range of the holographic storage disc. Accordingly, in the case that the cured region is formed as a ring shape or a circular arc shape corresponding to a part of the ring in the cure process mentioned above, the light energy may be irradiated onto the cured region mentioned above, by irradiating the light having a predetermined intensity at a predetermined timing corresponding to the cured region in a state of turning the holographic storage disc at a predetermined linear velocity. In this case, it is often the case that the controllability is better by carrying out the turning control of the holographic storage disc by the direct-current motor than by the stepping motor. In this case, the disc control at a time of the cure process may be carried out by the direct-current motor.

The motion flow from the preparation finish state to the reproduction of the recorded information is as shown in FIG. 6. In other words, the optical information recording and reproducing apparatus 10 carried out the various learning processes in advance as occasion demands in such a manner as to reproduce the information having the high quality from the holographic storage disc (SP20). Thereafter, the positions of the optical pickup 11 and the phase conjugate optical system 12 are arranged at the predetermined positions of the holographic storage disc while repeating the seek motion and the address reproduction (SP21 and SP22). Thereafter, the optical information recording and reproducing apparatus 10 emits the reference light from the holographic storage optical system of the optical pickup 11 and reads the information recorded on the holographic storage disc (SP23).

In this case, as mentioned above, it is desirable that the holographic storage disc 1 stands still at a time of recording and reproducing the information, in order to obtain a sufficient light energy for stably recording the information on the holographic storage disc 1. Accordingly, in the present embodiment, for this purpose, there is employed the stepping motor 3 which can stably operate the rotation and the standstill of the holographic storage disc 1.

In this case, there is assumed a case of keeping the holographic storage disc 1 in the standstill state at a predetermined position (angle) in the control of the stepping motor 3.

In the case of fixing the motion of the motor shaft at the predetermined position (angle) in the general stepping motor control, the stepping motor control apparatus carries out a control motion in such a manner as to continuously generate such an electromagnetic force as to keep the position (angle). At this time, it is necessary to go on circulating an electric current having such an electric angle vector that a combined vector of the electromagnetic forces keeps a predetermined position (angle), to each of a plurality of coils of the stepping motor, and an electric power consumption and a heat generation are generated.

Since it is not desirable that the electric power consumption and the heat generation are generated in the stepping motor in spite that the holographic storage disc is in the standstill state, the following methods are used for reducing them. In other words, since a retention power necessary at a time of retaining the standstill state may be constituted by a smaller necessary electromagnetic force in comparison with a turning force necessary at a time of turning the motor so as to change the position (angle), there is provided the method of reducing the current amount circulating to the coil in such a manner that the combined vector of the electromagnetic forces comes to a combined vector which is smaller in spite of the same angle.

Further, in the present invention, it is possible to use a method mentioned below as a method which is inherent to the present invention for further reducing the electric power consumption and the heat generation. In other words, the structure is made such that the direct-current motor generates an electromagnetic brake force standing against the disc turning force, in the case that some kind or another disc turning force is applied, by shorting between the coil terminals of the direct-current motor in an electric circuit manner, in the stepping motor standstill position (angle) retention state, and there is constructed the retention force which is necessary at a time of retaining the standstill state in both the electromagnetic brake force and the position (angle) retention force of the stepping motor. Accordingly, it is possible to further reduce the electric power consumption and the heat generation which are necessary for obtaining the necessary retention force, in comparison with the case that the direct-current motor is not used together.

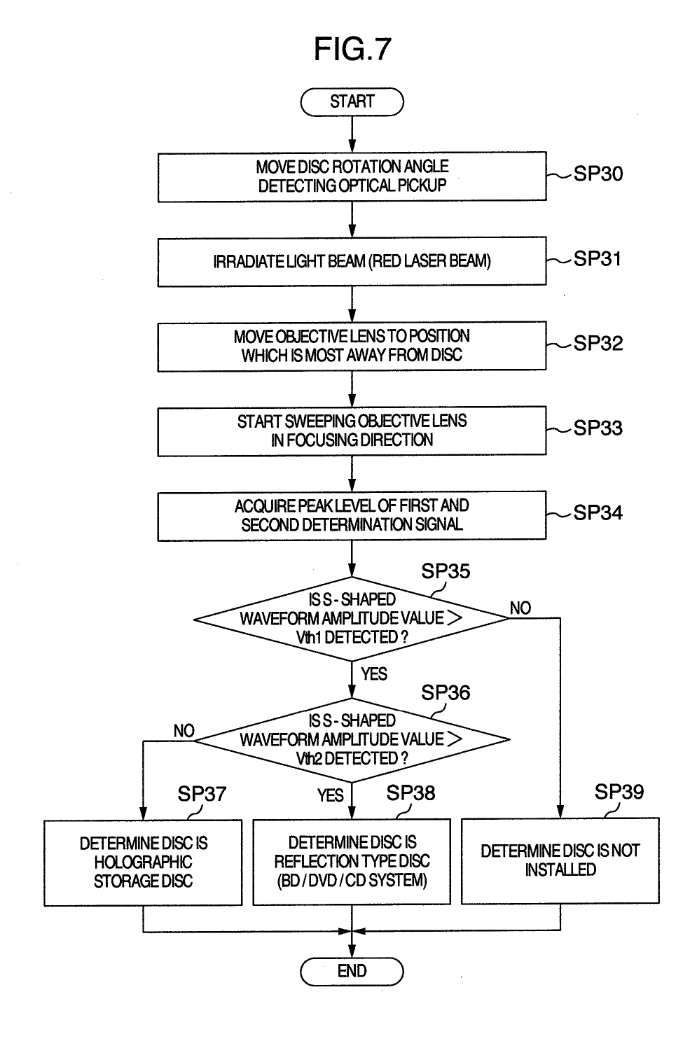

FIG. 7 is a flow chart showing an example of the specific processing content of the controller 89 with regard to the disc discriminating process mentioned above. The controller 89 executes the disc discriminating process shown in FIG. 7 on the basis of a control program installed in an internal memory (not shown).

In other words, the controller 89 starts the disc discrimination process if the controller 89 proceeds on to the disc discrimination (SP2) mentioned above in FIG. 4, and moves the disc rotation angle detecting optical system 14 to a position opposing to a predetermined position of the disc in the case that the disc is installed, by driving the slide mechanism (not shown) of the disc rotation angle detecting optical system 14, first of all (SP30).

Subsequently, the controller 89 feeds a driving current to the light source within the disc rotation angle detecting optical system 14 by driving the light source drive circuit 82 (refer to FIG. 1), thereby irradiating the optical beam (the red light beam) from the disc rotation angle detecting optical system 14 (SP31).

Thereafter, the controller 89 moves the objective lens to a position which is most away from the optical storage disc in the case that the optical storage disc is installed, by driving a biaxial actuator (not shown) retaining the objective lens within the disc rotation angle detecting optical system 14 (SP32).

Subsequently, the controller 89 starts moving the objective lens in a focusing direction by driving the biaxial actuator (SP33), and acquires a peak value of a signal level of first and second determination signals given from the reflection system disc detecting circuit 101 at this time (SP34).

Next, the controller 89 determines whether or not the peak value of the focus error signal gets over a first voltage threshold value (Vth1) on the basis of the peak value of the first determination signal acquired in the step SP34 (SP35). Further, if the controller 89 obtains a negative result in the determination, the controller 89 determines that the disc is not installed to the turn table 6 (SP39), and finishes the disc discriminating process.

On the other hand, if the controller 89 obtains a positive result in the determination of the step SP35, the controller 89 determines whether or not the peak value of the focus error signal gets over a second voltage threshold value (Vth2) (whether or not the peak value of the second determination signal is a positive value) on the basis of the peak value of the second determination signal acquired in the step SP34 (SP36).

Further, if the controller 89 obtains the negative result in the determination, the controller 89 determines that the installed disc is constituted by the holographic storage disc 1 (SP37), and if the controller 89 obtains the positive result, the controller 89 determines that the installed disc at that time is constituted by the optical storage disc 2, thereby finishing the disc discriminating process.

Since the signal having a frequency which is in proportion to the rotating speed of the direct-current motor 4 is generated in the coil 9 of the stepping motor 3, in the case that the controller 89 determines that the disc installed to the turn table 6 is constituted by the optical storage disc 2, and the direct-current motor 4 is driven, it is possible to detect the rotating speed of the direct-current motor 4 by measuring the frequency of the signal. Further, it is possible to prevent the electric current from flowing through the coil, whereby the brake is generated, by shutting off the current path for driving the stepping motor 3 in a circuit manner at a time when the direct-current motor 4 is driven, thereby preventing the electric current from flowing through the coil 9 of the stepping motor 3.

Further, in the case that the direct-current motor 4 is constituted by a brushless motor having a Hall element and in the case that the controller 89 determines that the disc installed to the turn table 6 is constituted by the optical storage disc 2, and the stepping motor 3 is driven, the signal corresponding to the position of the magnet 8 in the rotor 7 of the stepping motor 3 is generated in the Hall element of the direct-current motor 4. Accordingly, it is possible to detect whether or not the turn table 6 stops by measuring the frequency of the signal. Further, since the signal having the frequency which is in proportion to the rotating speed of the stepping motor 3 is generated in the coil 19 of the direct-current motor 4, it is possible to detect the rotating speed of the stepping motor 3 by measuring the frequency of the signal. Further, it is possible to prevent the brake from being generated due to the current flow in the coil 19, by shutting off the current path for driving the direct-current motor 4 in a circuit manner, and preventing the electric current from flowing through the coil 19 of the direct-current motor 4.

Further, since the signal having the frequency which is in proportion to the rotating speed of the stepping motor 3 is generated in the coil 19 of the direct-current motor 4, in the case that the direct-current motor 4 is constituted by a brushless motor having no Hall element, and in the case that the controller 89 determines that the disc installed to the turn table 6 is constituted by the optical storage disc 2 and the stepping motor 3 is driven, it is possible to detect the rotating speed of the stepping motor 3 by measuring the frequency of the signal. Further, in the case of this structure, it is possible to prevent the brake from being generated by shutting off the current path for driving the direct-current motor 4 in a circuit manner, at a time when the stepping motor 3 is driven.

In this case, when any one of the stepping motor 3 and the direct-current motor 4 is driven, an electric voltage is generated in a coil terminal of the coil which is not driven, on the basis of an electromagnetic induction in accordance with a principle of a power generator. The electric voltage generated in the coil terminal of the motor which is not driven at this time is an electric voltage corresponding to the power generator in a no-load state, for example, at a time of turning the disc at a high speed about some thousands rpm to some tens thousand rpm for recording and reproducing the conventional DVD disc at a high speed by using the direct-current motor 4, there is a case that a higher electric voltage than the electric voltage fed from the drive circuit is generated in the case of driving the stepping motor 3 between the coil terminals of the stepping motor 3. Accordingly, it is necessary to set an excess voltage protection circuit for preventing the current isolating circuit and the motor drive circuit connected to the coil terminal from being broken by the high voltage. In this case, since it is necessary to prevent the electric current from flowing through the coil in the excess voltage protection circuit necessary here, even in the case that the excess voltage protection circuit comes into a protection state due to an application of the excess voltage, a desired purpose can not be achieved by a structure which prevents a voltage increase by circulating the electric current in a circuit element having a low impedance at a time of applying the excess voltage such as a normal excess voltage protection circuit. Then, in the excess voltage protection circuit in accordance with the present invention, it is necessary to have such a withstand voltage as to maintain the shutoff state even at the high voltage which may be generated in the coil terminal, and protect such that the circuit block such as the current isolating circuit, the motor drive circuit or the like connected to the coil is not broken by the leakage current or the like, even in the case mentioned above.

In this case, in the present embodiment, the description is given of the case that the outer diameter of the stepping motor 3 is structured such as to be approximately equal to the outer diameter of the direct-current motor 4, and the direct-current motor 4 is arranged in the turn table 6 side, however, the structure is not limited to this, but the optical information recording and reproducing apparatus in accordance with the present invention may be provided with the other structures as far as the rotating shaft of the stepping motor 3 and the rotating shaft of the direct-current motor 4 are constructed by the common rotating shaft 5.

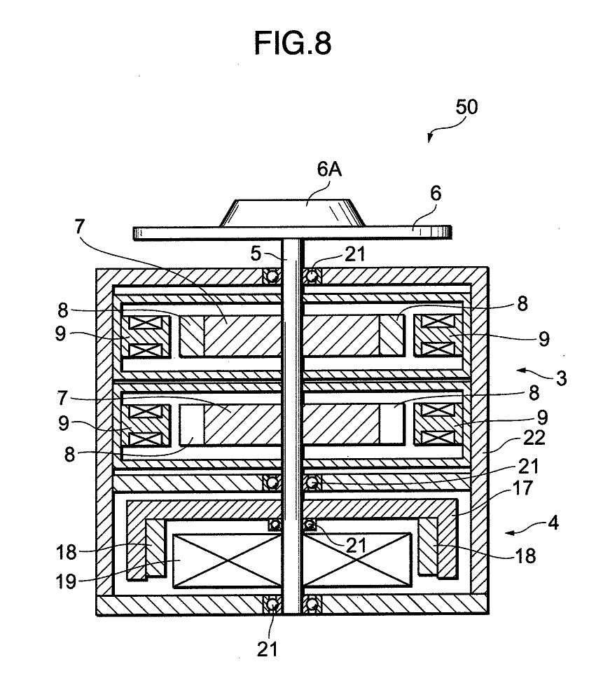

Specifically, for example, as shown in FIG. 8, the outer diameter of the stepping motor 3 may be structured such as to be approximately equal to the outer diameter of the direct-current motor 4, and the stepping motor 3 may be arranged in the turn table 6 side. In the case of this structure, it is possible to achieve the downsizing, the thin structure and the low cost in the same manner as the optical information recording and reproducing apparatus 10 in accordance with the embodiment mentioned above, and it is possible to simply divert the conventional motor mechanism. Further, since the outer diameter of the stepping motor 3 is designed comparatively large, there is an advantage that it is possible to easily increase the pole number and it is easy to improve the angular resolution.

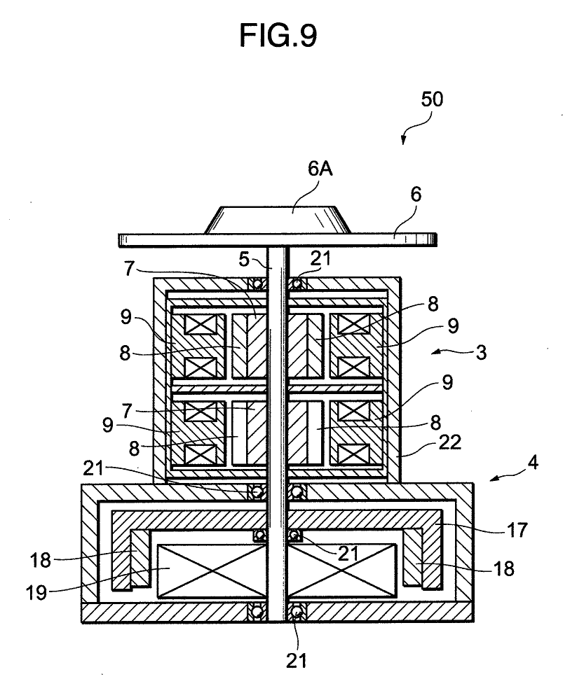

Further, the motor portion 50 of the optical information recording and reproducing apparatus in accordance with the present invention may be structured, for example, as shown in FIG. 9, such that the outer diameter of the stepping motor 3 is smaller than the outer diameter of the direct-current motor 4, and the stepping motor 3 is arranged in the turn table 6 side. In the case of this structure, since the outer diameter of the stepping motor 3 is small, there is an advantage that the optical pickup 11 is hard to be interfered with the motor portion 50, for example, even if the optical pickup 11 moves to an inner side (a direction coming close to the rotating shaft 5). Further, in the case of this structure, in order to make a capacity of the stepping motor 3 identical to a capacity of the stepping motor 3 (refer to FIGS. 3 and 8) having the outer diameter which is approximately equal to the outer diameter of the direct-current motor 4, it is necessary to make a length (a thickness) in a direction along the rotating shaft 5 of the stepping motor 3 thicker than the case of the structure shown in FIGS. 3 and 8, however, since a moment of inertia of the stepping motor 3 becomes small, it is advantageous at a time when the rotating speed is changed.

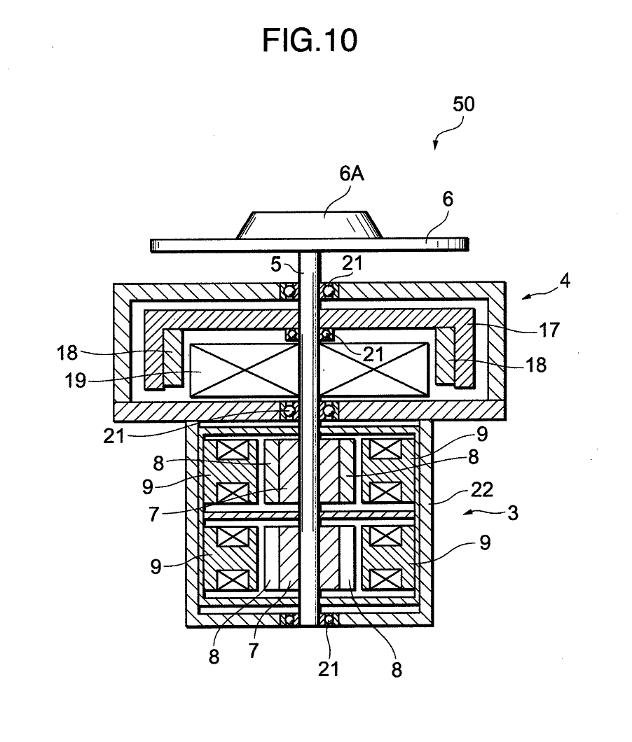

Further, the motor portion 50 of the optical information recording and reproducing apparatus in accordance with the present invention may be structured, for example, as shown in FIG. 10, such that the outer diameter of the stepping motor 3 is smaller than the outer diameter of the direct-current motor 4, and the direct-current motor 4 is arranged in the turn table 6 side. Even in the case of this structure, in the same manner as the structure shown in FIG. 9, the optical pickup 11 is hard to be interfered with the motor portion 50 even if the optical pickup 11 moves to the inner side (the direction coming close to the rotating shaft 5), and the moment of inertia of the stepping motor 3 becomes small. Accordingly, the structure is advantageous at a time when the rotating speed is changed. Further, in the case of the structure shown in FIG. 10, since a distance between the direct-current motor 4 and the turn table 6 is made identical to a distance between the direct-current motor in the conventional motor provided with only the direct-current motor and the turn table, there is an advantage that a shaft resonance is hard to be generated.

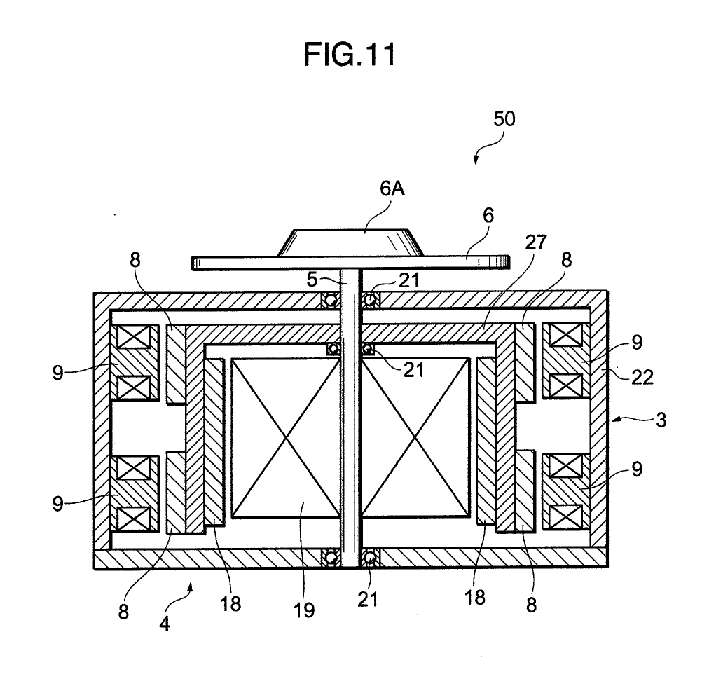

Further, the motor portion 50 of the optical information recording and reproducing apparatus in accordance with the present invention may be structured, for example, as shown in FIG. 11, such that the stepping motor 3 and the direct-current motor 4 are arranged concentrically in such a manner that the direct-current motor 4 is arranged in an inner peripheral side and the stepping motor 3 is arranged in an outer peripheral side around the rotating shaft 5, and the rotor of the stepping motor 3 and the rotor of the direct-current motor 4 are constructed by a common rotor 27. Specifically, the direct-current motor 4 is provided with a rotor 27 having an approximately C-shaped cross section and attached to the outer periphery of the rotating shaft 5, a magnet 18 attached to an inner peripheral surface of the rotor 27, and a coil 19 arranged in an inner peripheral side so as to be spaced from the magnet 18. The stepping motor 3 is provided with the rotor 27, the magnet 8 attached to the outer periphery of the rotor 7, and the coil 9 arranged in an outer peripheral side so as to be spaced from the magnet 8. In the case of this structure, since the stepping motor 3 and the direct-current motor 4 are integrally structured, it is possible to make a volume of the motor portion 50 small in comparison with the structures shown in FIGS. 3, and 8 to 10. Accordingly, it is possible to make the moment of inertia smaller, and it is more advantageous at a time when the rotating speed is changed. Further, since the magnet 18 and the magnet 8 are arranged in the inner peripheral surface and the outer peripheral surface of one rotor 27, the structure is simple.

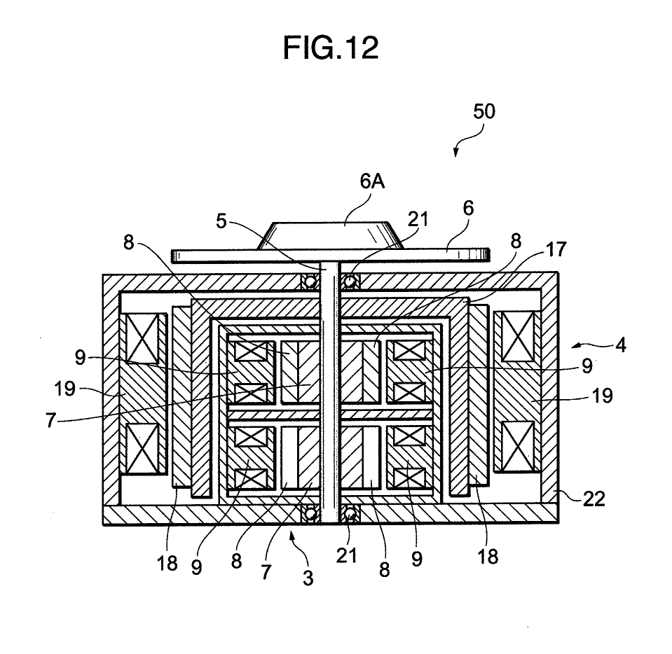

Further, the motor portion 50 of the optical information recording and reproducing apparatus in accordance with the present invention may be structured, for example, as shown in FIG. 12, such that the stepping motor 3 and the direct-current motor 4 are arranged concentrically in such a manner that the stepping motor 3 is arranged in the inner peripheral side and the direct-current motor 4 is arranged in the outer peripheral side, around the rotating shaft 5. In this case, in this structure, the direct-current motor 4 is provided with such a structure that the magnet 18 is arranged in an outer peripheral surface of the rotor 17, and the coil 19 is arranged in an outer peripheral side so as to be spaced from the magnet 18. Even in the case of this structure, since the stepping motor 3 and the direct-current motor 4 are integrally structured, it is possible to make the volume of the motor portion 50 small in comparison with the structure shown in FIGS. 3, and 8 to 10 mentioned above. Accordingly, it is possible to make the moment of inertia smaller, and it is advantageous at a time when the rotating speed is changed.

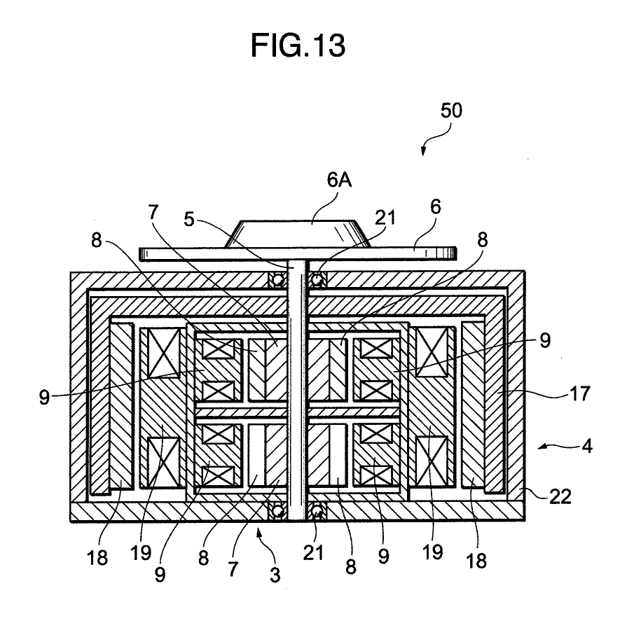

Further, the motor portion 50 of the optical information recording and reproducing apparatus in accordance with the present invention may be structured, for example, as shown in FIG. 13, such that the stepping motor 3 and the direct-current motor 4 are arranged concentrically in such a manner that the stepping motor 3 is arranged in the inner peripheral side and the direct-current motor 4 is arranged in the outer peripheral side around the rotating shaft 5. In this case, in this structure, the direct-current motor 4 is structured such that the magnet 18 is arranged in the inner peripheral surface of the rotor 17, and the coil 19 is arranged in the inner peripheral side (the stepping motor 3 side) so as to be spaced from the magnet 18. Even in this structure, since the stepping motor 3 and the direct-current motor 4 are integrally structured, it is possible to make the volume of the motor portion 50 small in comparison with the structure shown in FIGS. 3, and 8 to 10 mentioned above. Accordingly, it is possible to make the moment of inertia smaller, and it is advantageous at a time when the rotating speed is changed. Further, since the coils 9 and 19 corresponding to the stator are arranged collectively in comparison with the structure shown in FIG. 12, the structure is simple.

Further, in the present embodiment, as shown in FIGS. 3, and 8 to 13, the description is given of the case that the stepping motor 3 and the direct-current motor 4 are arranged in such a manner that the turn table 6 is retained in a horizontal state, however, the structure is not limited to this, but the stepping motor 3 and the direct-current motor 4 may be structured such that the disc installed to the turn table 6 is retained in a vertical state in correspondence to a size, a shape, a model such as a vertical type and a horizontal type and the like of the optical information recording and reproducing apparatus 10, and may be structured such that the disc is retained in an inclined state.

It should be further understood by those skilled in the art that although the foregoing description has been made on embodiments of the invention, the invention is not limited thereto and various changes and modifications may be made without departing from the spirit of the invention and the scope of the appended claims.

1. An optical information recording and reproducing apparatus recording an information on both a holographic storage disc and an optical storage disc recording and/or reproducing the information at a time of turning, and/or reproducing the information recorded on said both, by an optical pickup comprising:
a stepping motor driving said holographic storage disc; and
a direct-current motor driving said optical storage disc,
wherein a rotating shaft of said stepping motor and a rotating shaft of said direct-current motor are constituted by a common rotating shaft.

2. An optical information recording and reproducing apparatus as claimed in claim 1, further comprising:
a turn table arranged in said rotating shaft and being capable of installing both of said holographic storage disc and the optical storage disc;
a disc discriminating means discriminating which of said holographic storage disc and the optical storage disc the disc installed to said turn table is; and
a drive means selecting and driving a motor corresponding to the disc discriminated by said discriminating means.

3. An optical information recording and reproducing apparatus as claimed in claim 2, wherein said stepping motor and said direct-current motor are overlapped in an axial direction of said rotating shaft and said direct-current motor is arranged in said turn table side.

4. An optical information recording and reproducing apparatus as claimed in claim 2, wherein said stepping motor and said direct-current motor are overlapped in an axial direction of said rotating shaft and said stepping motor is arranged in said turn table side.

5. An optical information recording and reproducing apparatus as claimed in claim 2, wherein said stepping motor and said direct-current motor are arranged concentrically around said rotating shaft, said stepping motor is arranged in an outer side of said direct-current motor, and a rotor of said stepping motor and a rotor of said direct-current motor are constituted by a common rotor.

6. An optical information recording and reproducing apparatus as claimed in claim 2, wherein said stepping motor and said direct-current motor are arranged concentrically around said rotating shaft, and said direct-current motor is arranged in an outer side of said stepping motor.

7. An optical information recording and reproducing apparatus as claimed in any one of claims 2 to 6, wherein the optical information recording and reproducing apparatus measures a frequency of a signal generated in a coil of said stepping motor at a time when said direct-current motor is driven.

8. An optical information recording and reproducing apparatus as claimed in any one of claims 2 to 6, wherein the optical information recording and reproducing apparatus shuts off a current path feeding an electric current to said stepping motor in a circuit manner at a time when said direct-current motor is driven.

9. An optical information recording and reproducing apparatus as claimed in any one of claims 2 to 6, wherein said direct-current motor is constituted by a brushless motor having a Hall element, and the optical information recording and reproducing apparatus measures a signal generated in said Hall element at a time when said stepping motor is driven.

10. An optical information recording and reproducing apparatus as claimed in any one of claims 2 to 6, wherein the optical information recording and reproducing apparatus measures a frequency of a signal generated in a coil of said direct-current motor at a time when said stepping motor is driven.

11. An optical information recording and reproducing apparatus as claimed in any one of claims 2 to 6, wherein the optical information recording and reproducing apparatus shuts off a current path feeding an electric current to said direct-current motor in a circuit manner at a time when said stepping motor is driven.

12. An optical information recording and reproducing apparatus as claimed in claim 2, wherein the optical information recording and reproducing apparatus shorts between coil terminals of said direct-current motor in a circuit manner at a time of carrying out a control by said stepping motor and setting said holographic storage disc in a standstill state.

13. An optical information recording and reproducing apparatus as claimed in claim 2, wherein the optical information recording and reproducing apparatus turns said holographic storage disc by said direct-current motor at a time of turning said holographic storage disc for carrying out any process of a pre-cure and a post-cure with respect to the holographic storage disc.

14. An optical information recording and reproducing apparatus as claimed in claim 2, wherein the optical information recording and reproducing apparatus carries out a rotating speed control by said direct-current motor so as to continuously turn said holographic storage disc within a predetermined rotating speed, at a time of turning said holographic storage disc for carrying out any process of a pre-cure and a post-cure with respect to the holographic storage disc.

15. An optical information recording and reproducing apparatus as claimed in claim 1, further comprising:
a turn table arranged in said rotating shaft and being capable of installing both of said holographic storage disc and the optical storage disc;
a disc discriminating means discriminating which of said holographic storage disc and the optical storage disc the disc installed to said turn table is; and
a motor drive means turning the disc at a time of said discriminating means,
wherein said motor drive means drives said direct-current motor so as to turn the disc at a time when said disc discriminating means discriminates the disc.

16. An optical information recording and reproducing apparatus as claimed in claim 1, further comprising:
a turn table arranged in said rotating shaft and being capable of installing both of said holographic storage disc and the optical storage disc;
a disc discriminating means discriminating which of said holographic storage disc and the optical storage disc the disc installed to said turn table is; and
a motor drive means turning the disc at a time of said discriminating means,
wherein said motor drive means carries out a rotating speed control by said direct-current motor so as to continuously turn said disc within a predetermined rotating speed range at a time when said disc discriminating means discriminates the disc.
